(19) United States
(12) Patent Application Publication
(10) Pub. No.: US 2015/0149167 A1
(43) Pub. Date: May 28, 2015

(54) DYNAMIC SELECTION AMONG ACOUSTIC TRANSFORMS

(71) Applicants: Françoise Beaufays, Mountain View, CA (US); Johan Schalkwyk, Scarsdale, NY (US); Vincent Olivier Vanhoucke, San Francisco, CA (US); Petar Stanisa Aleksic, Jersey City, NJ (US)

(72) Inventors: Françoise Beaufays, Mountain View, CA (US); Johan Schalkwyk, Scarsdale, NY (US); Vincent Olivier Vanhoucke, San Francisco, CA (US); Petar Stanisa Aleksic, Jersey City, NJ (US)

(73) Assignee: GOOGLE INC., Mountain View, CA (US)

(21) Appl. No.: 13/249,509

(22) Filed: Sep. 30, 2011

Related U.S. Application Data
(63) Continuation of application No. 13/077,687, filed on Mar. 31, 2011.

(51) Int. Cl. G10L 15/26; G10L 25/54; G10L 15/197; G10L 25/27; G10L 15/20

(52) U.S. Cl. CPC G10L 25/54; G10L 15/265; G10L 25/27; G10L 15/197
USPC 704/235; 704/233; 704/235; 704/E15.043; 704/E15.039

(57) ABSTRACT

Aspects of this disclosure are directed to accurately transforming speech data into one or more word strings that represent the speech data. A speech recognition device may receive the speech data from a user device and an indication of the user device. The speech recognition device may execute a speech recognition algorithm using one or more user and acoustic condition specific transforms that are specific to the user device and an acoustic condition of the speech data. The execution of the speech recognition algorithm may transform the speech data into one or more word strings that represent the speech data. The speech recognition device may estimate which one of the one or more word strings more accurately represents the received speech data.

This application is a continuation of U.S. patent application Ser. No. 13/077,687, filed Mar. 31, 2011, the entire content of which is incorporated herein by reference.

### TECHNICAL FIELD

This disclosure relates to speech recognition.

### BACKGROUND

Users of devices, such as mobile devices, sometimes utilize mobile devices in “hands-free” operation. During hands-free operation, a user verbally provides speech, (e.g., speech data), to a mobile device. The mobile device may perform various functions in response to the speech data.

In some examples, to process the speech data, the mobile device may transmit the speech data to a server. The server may convert the speech data to one or more words that form the speech data, process the one or more words, and send back the results to the mobile device. For example, the server may perform an Internet search based on the one or more words, and transmit the results of the search to the mobile device for display to the user.

### SUMMARY

In one example, aspects of this disclosure are directed to a method comprising receiving speech data from a user device, receiving an indication of the user device, and executing a speech recognition algorithm that selectively retrieves at least one user and acoustic condition specific transform that is specific to the user device and specific to an acoustic condition comprising a context in which the speech data is provided, based on the indication of the user device, to convert the received speech data into one or more word strings that each represent the received speech data.

In another example, aspects of this disclosure are directed to a computer-readable storage medium comprising instructions that cause one or more processors to perform operations comprising receiving speech data from a user device, receiving an indication of the user device, and executing a speech recognition algorithm that selectively retrieves at least one user and acoustic condition specific transform that is specific to the user device and specific to an acoustic condition comprising a context in which the speech data is provided, based on the indication of the user device, to convert the received speech data into one or more word strings that each represent the received speech data.

In another example, aspects of this disclosure are directed to a speech recognition device comprising a transceiver that receives speech data from a user device and an indication of the user device, one or more storage devices that store at least one user and acoustic condition specific transform that is specific to the user device and specific to an acoustic condition comprising a context in which the speech data is provided, and means for executing a speech recognition algorithm that selectively uses the at least one user and acoustic condition specific transform, based on the indication of the user device, to convert the received speech data into one or more word strings that each represent the received speech data.

Aspects of this disclosure may provide one or more advantages. As one example, aspects of this disclosure may provide more accurate speech recognition result of conversion of speech data into one or more words, e.g., a word string, that can be processed by various devices, as compared to conventional techniques. An accurate speech recognition result may result in a device accurately performing functions based on the speech data. As another example, aspects of this disclosure may provide faster conversion of the speech data into one or more words. Faster conversion of the speech data into one or more words may result is less user-perceived latency, which may promote a better user experience.

The details of one or more aspects of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example communication system that may be implemented in accordance with one or more aspects of this disclosure.

FIGS. 2A and 2B are block diagrams illustrating two examples of speech recognition devices that may be implemented in accordance with one or more aspects of this disclosure.

FIG. 3 is a flowchart illustrating an example operation of a speech recognition device.

FIG. 4 is a flowchart illustrating another example operation of a speech recognition device.

### DETAILED DESCRIPTION

Certain example techniques of this disclosure are directed to selecting a user and acoustic condition specific transform, from a plurality of user and acoustic condition specific transforms, to convert speech that is verbally provided by a user into one or more words, e.g., a word string. Verbally provided speech may be referred to as speech data. As one example, a user may speak into a device, such as a mobile device, to provide the speech data. The mobile device may transmit the speech data to one or more speech recognition devices. A speech recognition device may select results of a speech recognition system that uses the acoustic condition specific transforms stored on the speech recognition device that may provide more accurate speech recognition results, as compared to the other transforms.

The speech recognition device may transmit the word string to one or more servers. The one or more servers may process the received word string to perform various functions. For example, the one or more servers may search the Internet for web sites based on the word string. The one or more servers may then transmit the results of the search to the mobile device for display to the user.

In some example implementations, the one or more speech recognition devices may store a plurality of user and acoustic condition specific transforms. A user and acoustic condition specific transform may be a transform that is specific for a user device and specific for an acoustic condition. As one example, a speech recognition device may store a user and acoustic condition specific transform that transforms speech data received by a first user device when the first user is in a noisy environment. As another example, a speech recognition device may store a user and acoustic condition specific transform that, when executed, converts speech data received by the first user device when the first user is in a quiet environment. As yet another example, a speech recognition device may store a user and acoustic condition specific transform that, when executed, converts speech data received by a second user device when the second user in a noisy environment, and so forth. The noisy and quiet acoustic conditions are provided for illustration purposes, and should be not considered as limiting. There may be more acoustic conditions other than noisy and quiet.

The user and acoustic condition specific transforms may be generated utilizing various techniques. As one non-limiting example, the user and acoustic condition specific transforms may be generated by first generating a user specific transform that is specific to a user. As described in more detail below, the user specific transform may be further adapted for different acoustic conditions to generate the plurality of user and acoustic condition specific transforms. Each of the plurality of user and acoustic condition specific transforms may be specific to the user, and specific for different acoustic conditions. This process may be repeated for each different user to generate user and acoustic condition specific transforms that are specific to that user, and specific for different acoustic conditions.

The user and acoustic condition specific transforms may be generated from an acoustic model. An acoustic model may be a statistical model of speech that is generated from different people in different acoustic conditions. The speech data used to generate the acoustic model may have been previously collected from different people in different acoustic conditions. The acoustic model may be a general model, in that the acoustic model may not be specific to a user or specific to an acoustic condition.

A processor may produce a user specific transform from the acoustic model, as described in more detail below. The processor may generate one or more user and acoustic specific transforms from the user specific transform, as described in more detail below.

As described above, the one or more speech recognition devices may store the user and acoustic condition specific transforms for user devices. In some example techniques of this disclosure, each speech recognition device may be configured to store all of the user and acoustic condition specific transforms for one or more user devices. In some alternate example techniques of this disclosure, the user and acoustic condition specific transforms for one user device may be stored in separate speech recognition devices.

A user of a user device may provide speech data. The user device may transmit the speech data to the one or more speech recognition devices. The user device may also transmit an indication of the user device or user. Based on the indication, a speech recognition device may determine whether it stores user and acoustic condition specific transforms for that user device. The speech recognition devices that store the user and acoustic condition specific transforms for that user device may estimate which user and acoustic specific transform provides a more accurate conversion of the speech data into one or more words that form the speech data, as compared to the other transforms.

The speech recognition device that stores the user and acoustic condition specific transforms that is estimated to provide the more accurate conversion of the speech data may select that transform for converting the speech data into one or more words that form the speech data. For example, after a user of a user device provides the speech data and an indication of the user device or the user, each of speech recognition devices that store user and acoustic condition specific transforms for that user device may process the speech data. In this manner, the user and acoustic condition specific transforms may convert the received speech data into different groups of one or more words, e.g., word strings, that each represent the received speech data. In some non-limiting examples, each group of word strings may be generated by each user and acoustic condition specific transform. The different groups of word strings may be generated by different user and acoustic condition specific transforms. The speech recognition devices may process the speech data using each one of the user and acoustic condition specific transforms either simultaneously or sequentially, as two examples.

In some non-limiting examples, provided for illustration purpose, each user and acoustic condition specific transform may output a confidence value that indicates the confidence level of the accuracy of the conversion of the speech data. The speech recognition device may then output the results from the selected user and acoustic condition specific transform that generated the highest confidence value. In some examples, the speech recognition device may output the results of the speech recognition system using the transforms to one or more servers for processing the word string generated from the user and acoustic condition specific transform.

As another example, after a user of a user device provides the speech data and an indication of the user device or the user, the speech recognition devices that store user and acoustic condition specific transforms for the user device may determine the acoustic condition of the speech data. Based on the acoustic condition of the speech data, the speech recognition devices may select the user and acoustic condition specific transform that is appropriate for the user device and the determined acoustic condition. The speech recognition device may then output the results from the selected user and acoustic condition specific transform. As above, in some examples, the speech recognition device may output the results of the selected user and acoustic condition specific transform to one or more servers for processing the word string generated from the speech recognition system using the user and acoustic condition specific transform.

There may be other possible techniques to select the user and acoustic condition specific transform that provides the more accurate speech recognition result. Aspects of this disclosure are not limited to the examples provided above. Aspects of this disclosure may utilize any technique to select the user and acoustic condition specific transform that provides the more accurate speech recognition result.

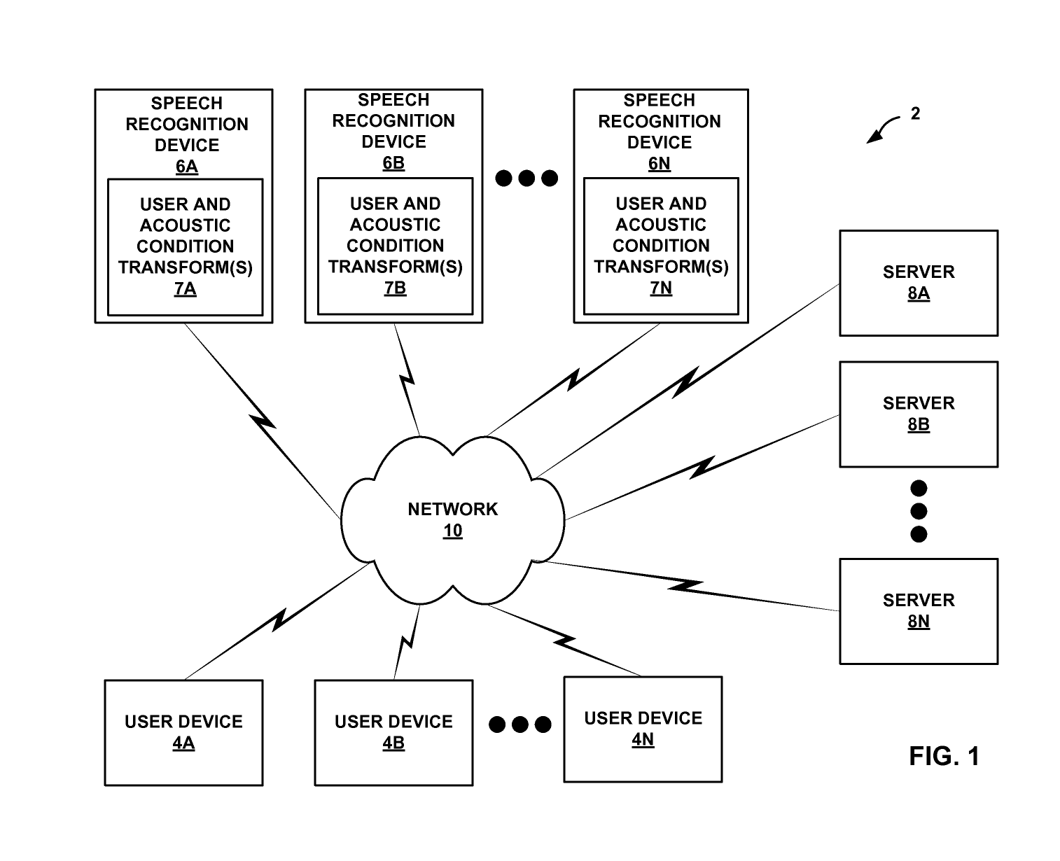

FIG. 1 is a block diagram illustrating an example communication system that may be implemented in accordance with one or more aspects of this disclosure. As illustrated in FIG. 1, communication system 2 includes user device 4A-4N (collectively referred to as “user devices 4”), speech recognition device 6A-6N (collectively referred to as “speech recognition devices 6”), server 8A-8N (collectively referred to as “servers 8”), and network 10. Although FIG. 1 illustrates three user devices 4, three speech recognition devices 6, and three servers 8, aspects of this disclosure are not so limited. In different examples, there may be more or fewer than three user devices 4, speech recognition devices 6, and servers 8. Also, the number of user devices 4, speech recognition devices 6, and servers 8 need not be the same, and may be different.

User devices 4 may be any device operated by users. Examples of user devices 4 include, but are not limited to, portable or mobile devices such as a cellular phones, personal digital assistants (PDAs), laptop computers, portable gaming devices, portable media players, e-book readers, tablets, as well as non-portable devices such as desktop computers.

Speech recognition devices 6 may be any device that stores user and acoustic condition transforms. In some examples, speech recognition devices 6 may store user and acoustic condition transforms for different users and for different acoustic conditions. In some examples, speech recognition devices 6 may also store acoustic models. Examples of speech recognition devices 6 include, but are not limited to, mainframe computers, network workstations, laptop computers, and desktop computers.

As illustrated in FIG. 1, speech recognition devices 6A-6N each include one or more user and acoustic condition transforms 7A-7N, respectively (collectively referred to as “user and acoustic condition transforms 7”). Each one of user and acoustic condition transforms 7 may include one or more user and acoustic condition transforms that are each specific to one or more user devices 4, and are each specific to an acoustic condition of speech data received from user devices 4. For example, user and acoustic condition transforms 7A may include one or more user and acoustic condition specific transforms for user devices 4A and 4B. User and acoustic condition transforms 7B may include one or more user and acoustic condition transforms for user devices 4B and 4D, as two non-limiting examples.

Each one of the user and acoustic condition specific transforms 7 may define parameters used by speech recognition devices 6 to convert the speech data into a word string. The parameters of the user and acoustic condition specific transforms 7 may be, as one non-limiting example, numerical values that speech recognition devices 6 uses to convert speech data into a word string. Some of the example implementations described in this disclosure refer to the user and acoustic condition specific transforms 7 as being stored on speech recognition devices 6, for ease of description. It should be noted that speech recognition devices 6 storing the user and acoustic condition specific transforms may also store the parameters, for specific users and acoustic conditions, which speech recognition devices 6 utilize to convert the speech data into a word string, e.g., one or more words.

As described in more detail below, user and acoustic condition specific transforms 7 may convert received speech data into one or more words, e.g., word string, that form the received speech data. The word string may represent individual words within the speech data. For example, if the speech data is “flower shops in San Francisco,” the word string may include “flower,” “shops,” “in,” “San,” and “Francisco,” to form the word string “flower shops in San Francisco.” If, however, the transformation of the speech data into a word string is incorrect, the resulting word string may be “floor shops in San Francisco,” as one example.

Servers 8 may be any device that stores data for transmission to user devices 4. Examples of servers 8 include, but are not limited to, mainframe computers, network workstations, laptop computers, and desktop computers. As described in more detail below, servers 8 may receive one or more words, e.g., word strings, that form the speech data received from user devices 4. Servers 8 may receive the word strings from at least one of speech recognition devices 6. Servers 8 may perform various functions based on the received word string. Servers 8 may then transmit the results of the functions to one of user devices 4 from which the speech data originated.

Network 10 may be any network that facilitates communication between user devices 4, speech recognition devices 6, and servers 8. Network 10 may be a wide variety of different types of networks. Examples of network 10 include, but are not limited to, the Internet, a content delivery network, a wide-area network, or another type of network.

As illustrated in FIG. 1, user devices 4, speech recognition devices 6, and severs 8 may be wirelessly coupled to network 10 and may wirelessly communicate with one another via network 10. However, aspects of this disclosure are not so limited. In some alternate examples, user devices 4, speech recognition devices 6, and servers 8 may be coupled with a wired connection, such as an Ethernet line or optical line, to network 10. In some alternate examples, user devices 4 may be wirelessly coupled to network 10, and speech recognition devices 6 and servers 8 may be coupled to network 10 via a wired connection.

There are other permutations and combinations of wireless and wired connections between network 10 and user devices 4, speech recognition devices 6, and servers 8. Aspects of this disclosure are not limited to specific wireless and wired connections described above. For purposes of illustration, aspects of this disclosure are described in the context of wireless connections with network 10.

A user of one of user devices 4, (e.g., user device 4A) may provide speech data to user device 4A. Speech data may be any speech that is provided by the user. For example, user device 4A may include a microphone. The user may speak into the microphone, and the speech provided to the microphone may be the speech data. User device 4A may transmit the speech data to network 10. User devices 4B-4N may function in a substantially similar manner.

Speech data may be speech that causes user devices 4, or some other devices such as servers 8, to perform one or more functions. As one example, speech data may be provided in the context of “voice search.” In voice search, a user of one of user devices 4, e.g., user device 4A, executes an application that forwards its speech data to one or more servers 8 which performs a search for items on the Internet. The user may then verbally provide user device 4A with the items to be searched. For example, the user may say “flower shops in San Francisco.” In response, at least one of speech recognition devices 6 may convert the speech data into one or more words, e.g., a word string, which forms the received speech data.

For instance, keeping with the previous example, one of speech recognition devices 6 may convert, utilizing user and acoustic condition transforms 7, the received speech data into a word string that includes “flowers shops in San Francisco.” Speech recognition devices 6 may then transmit the word string to servers 8. Servers 8 may perform the search for “flower shops in San Francisco,” and transmit the results of the search to user device 4A because, in this example, user device 4A originated the speech data.

There may be other examples of speech data. Aspects of this disclosure should not be considered limited to speech data in the context of voice searching. Rather, speech data may include any speech by users of user devices 4.

User devices 4 may not, in some cases, be capable of processing the speech data into executable commands. To perform functions in accordance with the speech data, the speech data may need to be converted into digital signals that represent the speech data. For example, the speech data “flower shops in San Francisco,” may need to be converted to a word string that forms the speech data. The word string may include one or more words that form the speech data. For example, after the speech data “flower shops in San Francisco” is converted to a word string, servers 8 may receive the word string and may be able to search for flower shops in San Francisco based on the received word string. In some instances, without the conversion of speech data to a word string, servers 8 may not be able to process the speech data.

Conversion of speech data into a word string may require extensive processing. User devices 4 may not include sufficient computing capabilities to convert all types of speech data. For example, user devices 4 may include sufficient computing capabilities to convert relatively small amounts of speech data, but may not include sufficient computing capabilities to accurately convert all instances of speech data. In some instances, user devices 4 may offload the conversion of speech data to a word string to another device, such as speech recognition devices 6, to reduce the amount of power consumed by user devices 4. For instance, in examples where user devices 4 are mobile devices, each mobile device may be configured to limited computing capabilities that are shared with different processes executing on such user devices 4. Due to the limited processing capabilities, the mobile devices may offload the conversion of speech data to a word string to speech recognition devices 6. In these examples, speech recognition devices 6 may convert the speech data into a word string, rather than user devices 4.

User devices 4 may transmit the speech data to one or more speech recognition devices 6 for conversion of the speech data into one or more groups of word strings that represent the speech data. To transmit the speech data, user devices 4 may transmit the speech data to network 10. Network 10 may then transmit the speech data to one or more speech recognition devices 6.

Each one of speech recognition devices 6 may store a plurality of user and acoustic condition specific transforms, such as user and acoustic condition transforms 7. Each one of speech recognition devices 6 may be configured to implement each one of user and acoustic condition specific transforms 7 to convert the speech data into a word string. Each one of user and acoustic condition specific transforms 7 may be specific to a user device and specific to an acoustic condition. As used in this disclosure, implementing each one of the user and acoustic specific condition transforms may be considered as executing speech recognition algorithms that use the one or more user and acoustic specific condition transforms.

The acoustic condition of the speech data may be the context in which the user provides the speech data. The acoustic condition of the speech data may include various components. For example, the acoustic condition of the speech data may be based on the gender of the user, the environment in which the speech data is provided, the manner in which the speech data is provided, and the communication channel between user devices 4 and network 10 as a few non-limiting examples of components of the acoustic conditions of speech data. The acoustic condition of speech data may be considered as characteristics of the speech data.

As one example, speech data from a male may have different speech characteristics compared to speech data from a female. As another example, speech data provided in a noisy environment, such as in a restaurant, train, or a public setting, may have different speech characteristics compared to speech data provided in a quiet environment, such as an office. As yet another example, the manner in which the user provides the speech data may affect the speech characteristics of the speech. For instance, a user may provide speech data where one of user devices 4 is located proximate to the user's mouth or further away from the user's mouth. For example, the user may provide the speech data directly to user device 4A, or, user device 4A, may be in “speaker” mode and may be further away from the user (e.g., the user may place user device 4A on his or her desk). In this non-limiting example, the speech data when user devices 4 are proximate to the user may have different speech characteristics compared to speech data when user devices 4 are further away from the user.

In aspects of this disclosure, the user and acoustic condition transforms that are for a specific user and for the specific acoustic conditions may provide a more accurate speech recognition result, e.g., a more accurate conversion of speech data to a word string for those specific acoustic conditions. As one example, the user and acoustic condition specific transform for speech data provided in a noisy environment (e.g., noisy speech data) may provide more accurate speech recognition results when the user is in a noisy environment, compared to the other user and acoustic condition specific transforms. For instance, the user and acoustic condition specific transform that is specific to the user and specific to a noisy environment may provide more accurate speech recognition results as compared to a transform that is not specific to the user and/or not specific to a noisy environment.

The examples described above are provided for illustration purposes and should not be considered limiting. The acoustic condition of the speech data should not be considered limited to gender, environment, manner in which the speech data is provided, or the communication channel condition. The acoustic condition of the speech data may include additional components than those described above.

As described above, speech recognition devices 6 may store a plurality of user and acoustic condition specific transforms, e.g., user and acoustic condition transforms 7, where each user and acoustic condition specific transforms defines different transforms that are user specific for particular acoustic conditions for conversion of the speech data into a word string. For example, for user device 4A, speech recognition device 6A may store user and acoustic condition specific transforms for female-quiet speech data, female-noisy speech data, male-quiet speech data, male-noisy speech data, male speech data provided when the user is proximate to user device 4A, male speech data provided when the user is further away from user device 4A, female speech data provided when the user is proximate to user device 4A, and female speech data provided when the user is further away from user device 4A, as well as speech data provided in different acoustic conditions. In this example, the user and acoustic condition specific transforms may be a part a speech recognition algorithm for conversion of speech data into a word string, where the transforms are specific to the examples of the acoustic conditions described above and specific to user device 4A, in this example.

Speech recognition devices 6 need not store every one of the user and acoustic condition specific transforms described above. In some examples, speech recognition devices 6 may store more or fewer user and acoustic condition specific transforms than those described above.

As described above, each one of speech recognition devices 6 may store a plurality of user and acoustic condition specific transforms. Also, as described above, each user and acoustic condition specific transform may be a part of a speech recognition algorithm to convert the speech data into a word string, where the transforms are specific to a particular acoustic condition of the speech data. For example, each user and acoustic condition specific transform may be applied to an acoustic model which is used by the speech recognition algorithm to convert the speech data into a word string. Also, as described above, each user and acoustic condition specific transform is specific for particular acoustic conditions of the speech data, and specific to each one of user devices 4.

For example, speech recognition device 6A may store a plurality of user and acoustic condition specific transforms, where each user and acoustic condition specific transform is specific to user device 4A, e.g., user and acoustic condition transforms 7A. As another example, speech recognition device 6B may store a plurality of user and acoustic condition specific transforms that are specific to user device 4B, e.g., user and acoustic condition specific transform 7B. As yet another example, speech recognition device 6A may store a plurality of user and acoustic condition specific transforms that are specific to user device 4A, and store a plurality of user and acoustic condition specific transforms that are specific to user device 4B. Speech recognition device 6B may also store a plurality of user and acoustic condition specific transforms that are specific to user device 4A, and also store a plurality of user and acoustic condition specific transforms that are specific to user device 4B. In this example, speech recognition device 6A may store some of the user and acoustic condition specific transforms for user device 4A and some of the user and acoustic condition specific transforms for user device 4B. Similarly, in this example, speech recognition device 6B may store some of the user and acoustic condition specific transforms for user device 4A and some of the user and acoustic condition specific transforms for user device 4B.

In aspects of this disclosure, each user and acoustic condition specific transforms may be used to convert speech data into a word string that is specific for a particular acoustic condition of the speech data and for a specific one of user devices 4. For example, speech recognition device 6A may store an acoustic condition transform for male speech data in a noisy environment that is specific to user device 4A. Speech recognition device 6A may also store an acoustic condition transform for male speech data in a quiet environment that is specific to user device 4B. Speech recognition device 6B may store an acoustic condition transform for female speech data in a quiet environment that is specific to user device 4A. Speech recognition device 6B may also store an acoustic condition transform for female speech data in a noisy environment that is specific to user device 4B.

The previous examples are provided for illustration purposes and should not be considered limiting. In examples of this disclosure, speech recognition devices 6 may store user and acoustic condition specific transforms for one or more of user devices 4. Also, in examples of this disclosure, the user and acoustic condition specific transforms for each one of user devices 4 may be stored in multiple speech recognition devices 6.

In examples of this disclosure, user devices 4 may transmit the speech data to one or more speech recognition devices 6. In addition to the speech data, in some examples, user devices 4 may transmit an indication of the user device. The indication may be an identifier that uniquely identifies one of user devices 4. For example, the indication may be a phone number associated with each one of user devices 4. Because the phone number of each one of user devices 4 may be different, the phone number may uniquely identify one of user devices 4. User devices 4 may be uniquely identified with other identifiers other than the phone number. The indication of one of user devices 4 should not be considered limited to phone numbers.

After one or more speech recognition devices 6 receive the speech data and the indication of user devices 4, each one of speech recognition devices 6 may determine whether it stores user and acoustic condition specific transforms for user devices 4 that transmitted the speech data based on the indication. For example, user device 4A may transmit the speech data and its phone number (e.g., the indication of user device 4A) to one or more speech recognition devices 6. Speech recognition device 6A may determine whether it stores user and acoustic condition specific transforms for user device 4A based on the phone number of user device 4A. Speech recognition devices 6B-6N may perform similar functions as speech recognition device 6A.

Speech recognition devices 6 that store user and acoustic condition specific transforms for user device 4A may estimate which user and acoustic condition specific transform would or does provide more accurate speech recognition results, e.g., more accurately converts the speech data into a word string. For example, assume speech recognition device 6A stores all of the user and acoustic condition specific transforms for user device 4A. Furthermore, assume that the user and acoustic condition specific transforms for user device 4A include a user and acoustic condition specific transforms for female-noisy speech data, female-quiet speech data, male-noisy speech data, and male-quiet speech data.

In one example, speech recognition device 6A may execute speech recognition algorithms that use the user and acoustic condition specific transforms in a sequential and parallel fashion utilizing the received speech data as an input for the mathematical model of the user and acoustic condition specific transforms. By executing speech recognition algorithms using the one or more of the user and acoustic condition specific transforms, speech recognition device 6A may convert the speech data into different groups of word strings, where each group is the word string generated from the execution of the speech recognition algorithm using the one or more user and acoustic condition specific transforms. In one example, the execution of the speech recognition algorithms using the one or more of the user and acoustic condition specific transforms may also generate a confidence value when executed. The confidence value may indicate the confidence level of the accuracy of the conversion of the speech data into a word string, e.g., the confidence level of the accuracy of the speech results. Speech recognition device 6A may then select the result from speech recognition algorithm that used a particular user and acoustic condition specific transform based on the confidence values. The result may be one of the groups of word strings that form the speech data. Speech recognition device 6A may transmit the selected word strings to servers 8 for further processing, as one example.

There may be other techniques, in addition to or instead of, confidence values to estimate which user and acoustic condition specific transforms, when used by the speech recognition algorithm, provided the more accurate speech recognition results. Aspects of this disclosure should not be considered limited to the example of confidence values to select the result from the executed speech recognition algorithm.

As another example, speech recognition devices 6 may determine which user and acoustic condition specific transform is the best candidate to execute to convert the speech data into a word string. For example, as with the previous example, assume that user device 4A transmitted the speech data, and that speech recognition device 6A stores all of the user and acoustic condition specific transforms for user device 4A. In this example, speech recognition device 6A may determine the acoustic condition of the speech data. Speech recognition device 6A may determine the acoustic condition in a tiered fashion, as one example.

For example, speech recognition device 6A may first determine whether the received speech data, from user device 4A, is speech data from a male or speech data from a female. In general, male speech data and female speech data may comprise different characteristics. Next, in this example, speech recognition device 6A may determine whether the speech data is provided in a noisy environment or a quiet environment. Speech recognition device 6A may execute the speech recognition algorithm using the appropriate user and acoustic condition specific transform based on the determinations.

For instance, assume that in the previous example, speech recognition device 6A determined that the speech data is from a male. Also, assume that speech recognition device 6A determined that the male speech data is provided in a noisy environment. In this example, speech recognition device 6A may execute the speech recognition algorithm using the user and acoustic condition specific transform that is specific to user device 4A and specific to the acoustic condition of male-quite speech data. In this example, speech recognition device 6A may then select the result from the executed user and acoustic condition specific transform. The result may be a word string that forms the speech data. Speech recognition device 6A may transmit the selected word string to servers 8 for further processing, as one example.

In this example, servers 8 may process the word string based on the desires of the user of user device 4A. For example, assume that the user of user device 4A desires to search for tickets to the Giants game. In this example, the user may speak “tickets to the Giants game.” Speech recognition device 6A may then convert the speech data into a word string that includes “tickets to the Giants game,” and transmit the word string to servers 8. Servers 8 may then search for tickets to the Giants game, and transmit the results to user device 4A.

In some examples, rather than transmitting the word string to servers 8, speech recognition device 6A may first transmit the word string to user device 4A for confirmation of the accuracy of the conversion. For example, speech recognition device 6A may transmit the word string “tickets to the Giants game” to user device 4A. User device 4A may then display the word string to the user for confirmation that the word string truly forms the speech data. After the user confirms the accuracy, use device 4A may transmit the word string to servers 8.

If the user indicates that the word string is incorrect, the user may provide the speech data again. Speech recognition device 6A may then convert the speech data into a word string for confirmation, and these steps may be repeated until the user confirms the accuracy of the word string.

The example of the user confirming the accuracy of the word string is provided for illustration purposes only and should not be considered as limiting. In alternate implementations, speech recognition devices may not transmit the word string to user devices 4 for confirmation of accuracy.

User devices 4 may receive the word string. User devices 4 may convert the received word string into characters for display for user confirmation. For example, user device 4A may convert the received word string into each word for the speech data “tickets to the Giants game.” User device 4A may then display the text “tickets to the Giants game” to the user.

The user may confirm the accuracy of the text. For example, the user may confirm that the displayed text corresponds to his or her speech data. To confirm the accuracy, the user may interact with a user interface of user device 4A. Confirmation of the accuracy of the text is not required in every example.

Aspects of this disclosure may provide one or more advantages. As one example, aspects of this disclosure may provide example techniques to more accurately convert speech data into a word string, e.g., provide more accurate speech recognition results, as compared to conventional techniques. The more accurate speech recognition results may result in user devices 4 performing the correct functions in accordance with the speech data.

Furthermore, in some instances, the example implementations of this disclosure may convert the speech data into a word string more quickly than conventional techniques. Because the user and acoustic condition specific transforms are specific to the user device and the acoustic condition, speech recognition devices 6 may more quickly convert the speech data into a word string. This in turn may reduce the overall latency before the user receives the search results because server 8 received the word string more quickly, as compared to conventional techniques.

Conventional techniques to convert speech data into a word string may rely on short-term conversion, long-term conversion, and speaker clustering. In the short-term conversion technique, a conventional speech recognition device adapts a single acoustic model based on the current speech data provided by the user. However, for short utterances of speech data, the single acoustic model may not include sufficient user data to accurately convert the speech data into word strings.

In the long-term conversion technique, a conventional speech recognition device modifies a single acoustic model based on current and past speech data provided by the user. However, users of user devices 4 may provide speech data in different acoustic conditions (e.g., in a quiet or noisy environment, as one example). The single acoustic model may be incapable of differentiating between the different acoustic conditions in which the user provided the speech data.

In the speaker clustering technique, a conventional speech recognition device selects an acoustic model based on current speech data provided by the user and previous speech data provided by different users. The speech recognition device determines which acoustic model should be used to convert the speech data into a word string. The speaker clustering technique utilizes speech provided by different users, in addition to the speech provided by the current user. However, the speaker clustering technique is not adapted for a specific user.

In examples of this disclosure, as described above, speech recognition devices 6 may store user and acoustic condition specific transforms that are specific to one of user devices 4 and specific to particular acoustic conditions. Speech recognition devices 6 may select the result from the user and acoustic condition specific transforms used by the speech recognition algorithm which may possibly, as an estimation, provide more accurate speech recognition results. Because the user and acoustic condition specific transforms are specific to one of user devices 4 and specific to the acoustic condition, the selected word string may be more accurate as compared to conventional techniques.

Aspects of this disclosure may provide additional advantages than those described above. As another example, although the above examples are described in the context of voice search, aspects of this disclosure are not so limited. The example implementations of this disclosure may be utilized in context of different types of speech data. For example, aspects of the disclosure may be utilized for applications related to navigation, e.g., applications for global position systems (GPS). As another example, aspects of the disclosure may be utilized for voice mail. There may be other example applications that utilize speech data, and aspects of this disclosure may be utilized in such applications.

As another example, aspects of this disclosure may be advantageous for multiple users of one of user devices 4. For instance, in examples where user devices 4 are mobile phones, a mobile phone may be used by more than one user. It may be common for multiple users to share a common mobile phone. For example, a husband and wife may share a common mobile phone, or a brother and sister may share a common mobile phone. In examples where multiple users utilize the same one of user devices 4, the acoustic conditions for the different users may vary largely. For example, the acoustic condition for the speech data from the husband may be substantially different than the acoustic condition for the speech data from the wife. By utilizing multiple user and acoustic condition specific transforms for specific user devices 4 and specific acoustic conditions, e.g., male or female speech data, adult or child speech data, aspects of this disclosure may provide more accurate conversion of speech data into a word string as compared to the conventional techniques.

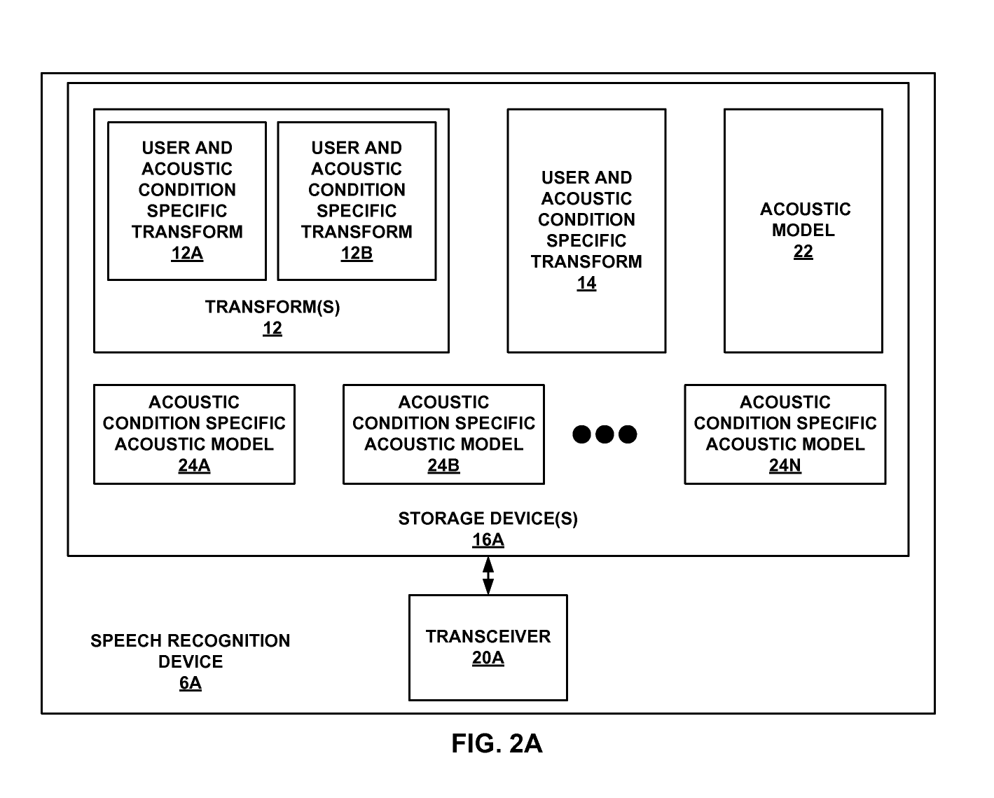

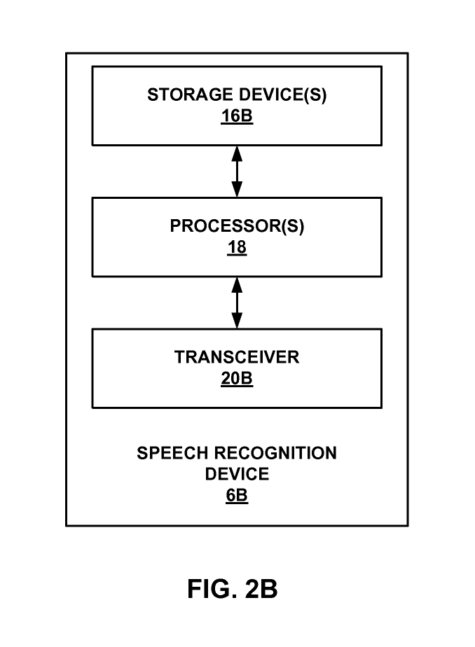

FIGS. 2A and 2B are block diagrams illustrating two examples of speech recognition devices that may be implemented in accordance with one or more aspects of this disclosure. FIG. 2A illustrates one example of speech recognition device 6A. FIG. 2B illustrates one example of speech recognition device 6B. Speech recognition device 6A includes one or more storage devices 16A, and transceiver 20A. Speech recognition device 6B includes one or more storage devices 16B, one or more processors 18, and transceiver 20B.

Transceiver 20A or 20B is configured to transmit data to and receive data from network 10. Transceiver 20A or 20B may support wireless or wired communication, and includes appropriate hardware and software to provide wireless or wired communication. For example, transceiver 20A or 20B may include an antenna, modulators, demodulators, amplifiers, and other circuitry to effectuate communication between speech recognition device 6A or 6B, respectively, and network 10.

One or more storage devices 16A or 16B may include any volatile, non-volatile, magnetic, optical, or electrical media, such as a hard drive, random access memory (RAM), read-only memory (ROM), non-volatile RAM (NVRAM), electrically-erasable programmable ROM (EEPROM), flash memory, or any other digital media. For ease of description, aspects of this disclosure are described in the context of a single storage device 16A or 16B. However, it should be understood that aspects of this disclosure described with a single storage device 16A or 16B may be implemented in one or more storage devices.

Storage device 16A or 16B may, in some examples, be considered as a non-transitory storage medium. The term “non-transitory” may indicate that the storage medium is not embodied in a carrier wave or a propagated signal. However, the term “non-transitory” should not be interpreted to mean that storage device 16A or 16B is non-movable. As one example, storage device 16A or 16B may be removed from speech recognition device 6A or 6B, and moved to another device. As another example, a storage device, substantially similar to storage device 16A or 16B, may be inserted into device speech recognition device 6A or 6B. In certain examples, a non-transitory storage medium may store data that can, over time, change (e.g., in RAM).

As illustrated in FIG. 2A, storage device 16A includes, of speech recognition device 6A, includes user and acoustic condition specific transform 12A and user and acoustic condition specific transform 12B (collectively referred to as “transforms 12”). Storage device 16A also includes user and acoustic condition specific transform 14, referred to as transform 14 for ease of description.

In the example illustrated in FIG. 2A, transforms 12 may be transforms used by a speech recognition algorithm. The speech recognition algorithm may be executed, using transforms 12, to convert received speech data from user device 4A for different acoustic conditions into word strings. As one example, user and acoustic condition specific transform 12A may be specific to user device 4A and may be specific to the male-noisy acoustic condition. As another example, user and acoustic condition specific transform 12B may be specific to user device 4A and may be specific to the female-noisy acoustic condition.

Similarly, transform 14 may be a transform used by the speech recognition algorithm. The speech recognition algorithm may be executed, using transform 14, to convert received speech data from user device 4B for a particular acoustic condition into a word string. For example, user and acoustic condition specific transform 14 may be specific to user device 4B and may be specific to the male-quiet acoustic condition.

Although FIG. 2A illustrates two transforms 12 for user device 4A and one transform 14 for user device 4B, aspects of this disclosure are not so limited. In some examples, storage device 16A may store more or fewer transforms 12 for user device 4A, and more transforms 14 for user device 4B. For instance, in addition to transforms 12, storage device 16A may store user and acoustic condition specific transforms that are specific to user device 4A and that are specific to male-quite acoustic condition, female-quite acoustic condition, as well as other possible acoustic conditions. Also, in addition to transform 14, storage device 16A may store user and acoustic condition specific transforms that are specific to user device 4B and that are specific to the male-noisy acoustic condition, male-quite acoustic condition, female-quite acoustic condition, as well as other acoustic conditions. It should be noted that the examples of male-noisy, female-noisy, male-quite, and female-quite are provided for illustration purposes, and should not be considered as limiting. There may be different types of acoustic conditions for which storage device 16A may store user and acoustic condition transforms other than the examples provided above.

Furthermore, although FIG. 2A illustrates that storage device 16A stores transforms 12 for user device 4A and transform 14 for user device 4B, aspects of this disclosure are not so limited. In some alternate examples, storage device 16A may store one or more user and acoustic condition specific transforms for user devices 4 in addition to or instead of user devices 4A and 4B. Also, in some alternate examples, storage device 16A may store transforms 12 for user device 4A, and not store transform 14. Similarly, in some alternate examples, storage device 16A may store transform 14, and may not store transforms 12.

Moreover, it may not be necessary for storage device 16A to store all of the user and acoustic condition specific transforms for user devices 4A and 4B. In some examples, storage device 16A may store some of the user and acoustic condition specific transforms for user device 4A, and one or more speech recognition devices 6B-6N may store the remaining user and acoustic condition specific transforms for user device 4A. Also, in some examples, storage device 16A may store some of the user and acoustic condition specific transforms for user device 4B, and one or more speech recognition devices 6B-6N may store the remaining user and acoustic condition specific transforms.

As illustrated in FIG. 2B, speech recognition device 6B may include one or more storage devices 16B, which for purposes of description may be referred to as a single storage device 16B. Speech recognition device 6B may also include one or more processors 18, and transceiver 20B. In some examples, storage device 16B may be substantially similar to storage device 16A (FIG. 2A). For instance, storage device 16B may also store user and acoustic condition specific transforms for one or more user devices 4. However, storage device 16 need not store user and acoustic condition specific transforms for one or more user devices 4.

In some examples, storage device 16B may store one or more instructions that cause one or more processors 18 to perform various functions ascribed to one or more processors 18. Storage device 16B may be considered as computer-readable storage media comprising instructions that cause one or more processors 18 to perform various functions.

One or more processors 18 may include any one or more of a microprocessor, a controller, a digital signal processor (DSP), an application specific integrated circuit (ASIC), a field-programmable gate array (FPGA), or equivalent discrete or integrated logic circuitry. For ease of description, aspects of this disclosure are described in the context of a single processor 18. However, it should be understood that aspects of this disclosure described with a single processor 18 may be implemented in one or more processors.

Processor 18 may execute speech recognition algorithms that use transforms 12 and transform 14 to convert received speech data into one or more word strings. The speech recognition algorithm may be an algorithm used to convert speech data into a word string. The speech recognition algorithm may be stored on storage device 16B and may be executed by processor 18. For example, processor 18 may execute the speech recognition algorithm, and the speech recognition algorithm may use one or more of transforms 12 or transform 14, as applicable based on which one of user devices 4 transmitted the speech data, to convert the speech data into a word string.

In some examples, prior to converting the speech data into one or more word strings, processor 18 may determine which transforms, e.g., transforms 12 or transform 14, the speech recognition algorithm should use. Speech recognition device 6B may receive speech data, with transceiver 20B, from one or more user devices 4 and indication of one or more user devices 4. For instance, speech recognition device 6B may receive speech data from user device 4A and an indication that user device 4A transmitted the speech data. Processor 18 may determine that user device 4A transmitted the speech data based on the indication of user device 4A.

The indication of user device 4A may be the phone number of user device 4A, although the indication of user devices 4 should not be considered limited to phone numbers. In this example, storage device 16B may store the phone numbers of user devices 4. Processor 18 may receive the phone number transmitted by user device 4A and compare the phone number to the stored phone numbers. Based on the comparison, processor 18 may determine which ones of speech recognition devices 6 store user and acoustic condition specific transforms for user device 4A.

For example, storage device 16B may store information indicating which ones of speech recognition devices 6 store user and acoustic condition specific transforms that are specific to user device 4A. In the example illustrated in FIGS. 2A and 2B, storage device 16B may store information that indicates that speech recognition device 6A stores transforms 12 which are user and acoustic condition transforms that are specific to user device 4A.

Processor 18 may cause transceiver 20B to transmit a request to speech recognition device 6A to retrieve the parameters of transforms 12. In this example, processor 18 may cause transceiver 20B to request transforms 12 because transforms 12 are specific to user device 4A. If user device 4B transmitted the speech data, processor 18 may cause transceiver 20B to request for transform 14 because transform 14 is specific to user device 4B. Processor 18 may request for the transforms that are specific to the user device based on the user device that transmitted the speech data.

Transceiver 20A of speech recognition device 6A may receive the request from processor 18. In response to the request, transceiver 20A may transmit information about how transforms 12 transform the speech data to transceiver 20B, which in turn may transmit the information to processor 18. In this manner, when processor 18 executes the speech recognition algorithm, the speech recognition algorithm can transform the speech data based on transforms 12.

In one example, processor 18 may execute the speech recognition algorithm multiple times using each one of transforms 12 to convert the received speech data into a word string. Processor 18 may execute the speech recognition algorithm multiple times using transforms 12 sequentially or in parallel. As one example, utilizing the received speech data as an input to the mathematical models, processor 18 may execute the speech recognition algorithm using user and acoustic condition specific transform 12A to generate a first word string. Then, processor 18 may execute the speech recognition algorithm using user and acoustic specific transform 12B to generate a second word string. The first word string may include a first group of one or more words, and the second word string may include a second group of one or more words. The first and second word strings may be referred to as different groups of one or more words. In this manner, processor 18 may execute the speech recognition algorithm multiple times and sequentially using transforms 12.

As another example, utilizing the received speech data as an input to the mathematical models, processor 18 may execute the speech recognition algorithm multiple times in parallel using user and acoustic condition specific transforms 12A and 12B. In this example, in parallel, processor 18, executing the speech recognition algorithm in parallel, may generate the first and second word stings. As above, the first and second word strings may be referred to as different groups of one or more words.

In these examples, e.g., where processor 18 executes the speech recognition algorithm using transforms 12 in parallel or sequentially, processor 18 may determine which one of transforms 12 is estimated to have generated a more accurate speech recognition result. As one example to estimate which of transforms 12 is likely to have generated a more accurate speech recognition result, during execution of the speech recognition algorithms, processor 18 may generate a confidence value. The confidence value may indicate the accuracy of the conversion of the speech data into a word string. Based on the confidence values, processor 18 may estimate which one of transforms 12 generated the more accurate speech recognition results, e.g., a word string that includes one or more words.

It should be noted that utilizing confidence values is one example technique to estimate which transform generated the more accurate speech recognition results. However, aspects of this disclosure are not so limited. In some alternate example implementation, processor 18 may utilize values instead of or in addition to confidence values to estimate which transform generated the more accurate speech recognition results.

For purposes of illustration, the following is one example implementation of some of the non-limiting aspects of this disclosure. In this example, assume that the user of user device 4A is a female in a noisy environment. The user device 4A may transmit the speech data to speech recognition device 6B and the phone number of user device 4A (e.g., indication of user device 4A). Processor 18 of speech recognition device 6B may determine that user device 4A transmitted the speech data by comparing the phone numbers stored in storage device 16B with the received phone number of 4A.

Processor 18 may then determine which ones of speech recognition devices 6 store user and acoustic condition specific transforms for user device 4A based on information stored in storage device 16B. In this example, processor 18 may determine that speech recognition device 6A stores user and acoustic condition specific transforms 12A and 12B. Processor 18 may retrieve the parameters of user and acoustic condition specific transforms 12A and 12B to execute the speech recognition algorithm using user and acoustic condition specific transforms 12A and 12B.

Processor 18 may execute the speech recognition algorithm multiple times using user and acoustic condition specific transforms 12A and 12B, either in parallel or sequentially. Also, during execution of the speech recognition algorithms, processor 18 may also generate confidence values for each one of user and acoustic condition specific transforms 12A and 12B when used by the speech recognition algorithm. As described above, in this example, the user is a female in a noisy environment. Also, as described above, user and acoustic condition specific transform 12A is specific to user device 4A and specific to the male-noisy acoustic condition, and user and acoustic condition specific transform 12B is specific to user device 4A and specific to female-noisy acoustic condition. In this example, the confidence value generated by executing the speech recognition algorithm using user and acoustic condition specific transform 12B may be greater than the confidence value generated by executing the speech recognition algorithm using user and acoustic condition specific transform 12A because the user of user device 4A is a female in a noisy environment.

Based on the confidence values, processor 18 may estimate that group of one or more words generated by the speech recognition algorithm using user and acoustic condition specific transform 12B is a more accurate speech recognition result as compared to the group of one or more words generated by the speech recognition algorithm using user and acoustic condition specific transform 12A. In this example, processor 18 may select the results, e.g., the group of one or more words, of user and acoustic condition specific transform 12B, and transmit the results, utilizing transceiver 20B to one or more servers 8 for further processing.

As described above, the speech recognition algorithm, executing on processor 18, may utilize each one of transforms 12 to generate different groups of one or more words to estimate which transform generated a more accurate speech recognition result. However, aspects of this disclosure are not so limited. In some examples, processor 18 may estimate which user and acoustic condition specific transform is a candidate transform for generating a more accurate speech recognition results as compared to the other user and acoustic specific transforms.

For instance, processor 18 may receive the speech data. Processor 18 may then determine the acoustic condition of the speech data. For example, processor 18 may extract the pitch of the speech data to determine whether the speech data is male speech data or female speech data. As another example, processor 18 may determine the quality of the speech data to determine whether the speech data was provided in a noisy environment or a quiet environment. The quality of the speech data may also indicate whether the user place the user device close to his or her mouth or further away from his or her mouth.

Based on the determined acoustic condition, processor 18 may determine which one of user and acoustic condition specific transform is specific to the user device and specific to the determined acoustic condition. For instance, processor 18 may receive speech data from a male user of user device 4B in a quiet environment. In this example, processor 18 may determine that the acoustic condition is male-quiet. Processor 18 may execute the speech recognition algorithm using user and acoustic condition specific transform 14 because user and acoustic condition specific transform 14 is specific to user device 4B and specific to the male-quiet acoustic condition. Processor 18 may then select the speech recognition results from the execution of the speech recognition algorithm using user and acoustic condition specific transform 14 for transmission to servers 8.

As described above, transforms 12 and transform 14 may be user and acoustic condition specific transforms for user devices 4A and 4B, respectively. Transforms 12 and transform 14 may be generated utilizing various techniques. In general, transforms 12 and transform 14 may be generated in advance and stored in storage device 16A. Transforms 12 and transform 14 may have been generated in advance by a computing device (not shown) and stored in storage device 16A. In some examples, processor 18 of speech recognition device 6B may be utilized to generate transforms 12 and transform 14 in advance.

For ease of description, processor 18 is described as generating transforms 12 and transform 14. However, it should be noted that in alternate examples, a computing device, other than processor 18, may generate transforms 12 and transform 14.

As illustrated in FIG. 2A, storage device 16A may include acoustic model 22. Acoustic model 22 may be a statistical model used to convert speech data into one or more words. Acoustic model 22 may not be specific to a user device and may not be specific to an acoustic condition. Acoustic model 22 may have been generated from previously collected speech data, and not necessarily from speech data transmitted by user devices 4.

Although acoustic model 22 is shown as a part of storage device 16A, aspects of this disclosure are not so limited. In some examples, acoustic model 22 may stored in a different one of speech recognition devices 6, e.g., speech recognition device 6B. In some examples, acoustic model 22 may be stored within the computing device that generated transforms 12 and transform 14, and may not be stored in any one of speech recognition devices 6.

Acoustic model 22 may be used to generate an acoustic condition specific transform. For example, based on data for specific acoustic conditions, processor 18 may utilize acoustic model 22 to generate an acoustic condition specific transform that is specific to that acoustic condition. The acoustic condition specific transform may then be used to generate the plurality of user and acoustic condition specific transforms, e.g., transforms 12 and transform 14. Storage device 16B, or a storage device of the computing device, may store previously collected speech data from users of user devices 4. For purposes of illustration, the stored previously collected speech data is described as being stored in storage device 16B. However, the stored previously collected speech data may be stored in another one of speech recognition devices 6, or in some other computing device.

In this example, each of previously collected speech data may be from specific user devices 4. For example, storage device 16B may store previously collected speech data from user device 4A, 4B, and so forth. For speech data collected from each one of user devices 4, processor 18 may generate user specific transforms with acoustic model 22 that are each specific to user devices 4. For example, processor 18 may utilize the speech data collected from user device 4A and the mathematical model of acoustic model 22 to generate user specific transforms that are specific to user device 4A. Similarly, processor 18 may utilize the speech data collected from user device 4B and the mathematical acoustic model 22 to generate user specific transforms that are specific to user device 4B, and so forth.

In some instances, the acoustic specific transforms may be better equipped to more accurately convert speech data into a word string, as compared to acoustic model 22. As described above, acoustic model 22 may not be specific to a user device or specific to an acoustic condition. Because the acoustic specific transform is generated specifically from the speech data for particular acoustic conditions, the acoustic specific transform may be better equipped to more accurately convert speech data into one or more words, as compared to acoustic model 22 that is not user specific.

Processor 18 may generate the acoustic condition specific transforms utilizing various techniques. Processor 18 may then adapt the acoustic condition specific transforms for each specific user to generate user and acoustic condition specific transforms.

As one example to generate one or more user and acoustic condition specific transforms 12 and 14, users of user devices 4 may tag the speech data to identify its acoustic condition. For example, the user of user device 4A may indicate, with user device 4A, that the user is in a noisy environment. The indication that the user is in a noisy environment may be tag that indicates that the speech data is provided by the user is in a noisy environment. Processor 18 may then generate the acoustic condition specific transform, which is specific to user device 4A, with the speech data received in the noisy environment to generate a user and acoustic condition specific transform which is specific to user device 4A when the user is in a noisy environment. Similarly, the user, with user device 4A, may indicate that the user is female and in a quiet environment. The indication that the user is female and in a quiet environment may be a tag that indicates that the speech data is provided by a female in a noisy environment. Processor 18 may then generate the acoustic condition specific transform, which is specific to user device 4A, with the speech data received by a female in a quite environment to generate a user and acoustic condition specific transform which is specific to a female user of user device 4A in a quite environment.

As another alternate example to generate one or more user and acoustic condition specific transforms, a transcriber may tag speech data to identify its acoustic condition. The example of the transcriber tagging the speech data is different than the above example where the user tags the speech data. For example, a transcriber may listen to the received speech data from user devices 4 and determine the acoustic condition in which the user provided the speech data. The transcriber may then tag the received speech data with the acoustic condition. Processor 18 may then adapt the user specific transform with the speech data to generate a user and acoustic condition specific transform based on the tag of the speech data which is specific to user devices 4.

It should be noted that the example of a transcriber tagging speech data may not be necessary in every example. For instance, to maintain privacy of the user, a transcriber may not have access to the speech data until the user provides consent. Since the user may not provide consent in all cases, the transcriber may not be able to tag the speech for all users.

As yet another example to generate one or more user and acoustic condition specific transforms, processor 18 may produce a plurality of acoustic condition specific acoustic models from acoustic model 22. For instance, processor 18 may utilize acoustic model 22 to generate a plurality of acoustic condition specific acoustic models that are specific to different acoustic conditions based on data for different acoustic conditions. For example, as illustrated FIG. 2A, storage device 16A may store acoustic condition specific acoustic model 24A-24N (collectively referred to as “acoustic condition specific acoustic models 24”).

Although FIG. 2A illustrates that storage device 16A stores acoustic condition specific acoustic models 24, it may not be necessary for storage device 16 to store acoustic condition specific acoustic models 24. In some example, acoustic condition specific acoustic models 24 may be shared among speech recognition devices 6. Also, in some examples, speech recognition devices 6 may not store acoustic condition specific acoustic models 24. In these examples, acoustic condition specific acoustic models 24 may be stored within a computing device that generated acoustic condition specific acoustic models 24.

Each of the plurality of acoustic condition specific acoustic models 24 may be specific to an acoustic condition, but may not be specific to one of user devices 4. Processor 18 may adapt each of acoustic condition specific acoustic models 24 with the user specific transform to generate the plurality of user and acoustic condition specific transforms, e.g., transforms 12 and transform 14. In some examples, acoustic condition specific acoustic models 24 may each be specific to pre-determined acoustic condition. For example, acoustic condition specific acoustic model 24A may be specific to the female-noisy acoustic condition. Acoustic condition specific acoustic model 24B may be specific to the female-quiet acoustic condition. Acoustic condition specific acoustic model 24C may be specific to the male-noisy acoustic condition. Acoustic condition specific acoustic model 24D may be specific to the male-quiet acoustic condition, and so forth.

The above example process to generate user and acoustic condition specific transforms may be referred to as a supervised training technique to generate user and acoustic condition specific transforms. The above example process may be referred to as a supervised training technique to generate user and acoustic condition specific transforms because the user and acoustic condition specific transforms are generated based on predefined acoustic condition specific acoustic models 24, e.g., male-noisy, male-quiet, female-noisy, and female-quite. However, aspects of this disclosure are not limited to example process for generating user and acoustic condition specific transforms described above.

As another example, processor 18 may implement an unsupervised training technique to generate acoustic condition specific acoustic models 24. One example, of the unsupervised training technique is described in “Unsupervised Discovery and Training of Maximally Dissimilar Cluster Models,” by Beaufays et al., published April 2010, and available at http://static.googleusercontent.com/external_content/untrusted_dlcp/research.google.com/en/us/pubs/archive/36487.pdf, the contents of which are incorporate by reference in their entirety.

In the unsupervised training technique, processor 18 may utilize acoustic model 22 and utilize a Gaussian Mixture Model (GMM) to differentiate between the acoustic conditions of the previously collected speech data. Based on the GMM distribution, processor 18 may generate acoustic condition specific acoustic models 24 by adapting the mathematical model of acoustic model 22. In some examples, processor 18 may generate more or fewer acoustic models than acoustic condition specific acoustic models 24.

Acoustic condition specific acoustic models 24 may include mathematical models that are for distinct acoustic conditions, but are not specific to any one of user devices 4. The distinct acoustic conditions need not be opposites of one another, e.g., need not be for male/female and noisy/quiet acoustic conditions. However, aspects of this disclosure are not so limited. It may be possible for the mathematical models of acoustic condition specific acoustic models 24 to naturally tend to algorithms for opposite acoustic conditions, but this is not a requirement of the unsupervised training technique.

From the acoustic condition specific acoustic models 24, processor 18 may generate a plurality of user and acoustic condition specific transforms. For example, the user of user device 4A may provide speech data in a specific acoustic condition, processor 18 may utilize the acoustic condition specific acoustic model 24 that is specific to the acoustic condition of the speech data received from user device 4A to generate a user and acoustic condition specific transform that is specific to user device 4A. Processor 18 may similarly generate additional user and acoustic condition specific transforms for user device 4A as the user of user device 4A provides speech data with different acoustic conditions. In this manner, based the unsupervised training technique, processor 18 may generate a plurality of user and acoustic condition specific transforms, e.g., transforms 12 and transform 14, that are specific to one of user devices 4 and specific to acoustic conditions.

As described above, processor 18 may determine which one of user devices 4 transmitted the speech data and convert the speech data into a word string by executing the speech recognition algorithm that uses at least one of the user and acoustic condition specific transform for the user device that transmitted the speech data. In some examples, processor 18 may then transmit the word string to one or more servers 8 for further processing. However, aspects of this disclosure are not so limited.

In some examples, processor 18 may utilize the mathematical model of acoustic model 22 to convert the received speech data into a word string. For example, assume that user device 4A transmitted the speech data. In this example, processor 18 may execute the speech recognition algorithm using one or more user and acoustic condition specific transforms 12A and 12B to generate different groups of one or more words, e.g., different groups of word string. Processor 18 may also utilize the mathematical model of acoustic model 22 to convert the received speech data into a group of one or more words. In this example, processor 18 may estimate which one of transforms 12 or acoustic model 22 resulted in more accurate speech recognition results, and may select the results for transmission based on the determination. As one example, processor 18 may determine which results should be transmitted based on confidence values, as described above; although, aspects of this disclosure are not so limited.

In some examples, processor 18 may utilize the mathematical model of acoustic condition specific acoustic models 24 to convert received speech data into groups of one or more words, e.g., word strings. For example, assume that user device 4B transmitted the speech. In this example, processor 18 may execute the speech recognition algorithm using user and acoustic condition specific transform 14 to generate groups of one or more words. Processor 18 may also utilize the mathematical model of acoustic condition specific acoustic models 24 to convert the received speech data into a group of one or more words. In this example, processor 18 may estimate which one of transform 14 or acoustic condition specific acoustic models 24 resulted in more accurate speech recognition results, and may select the results for transmission based on the determination.

In some examples, processor 18 may utilize user and acoustic condition specific transforms for user devices 4 from which the speech data was not received to convert received speech data into groups of one or more words, e.g., word strings. For example, assume that user device 4A transmitted the speech. In this example, processor 18 may execute the speech recognition algorithm using user and acoustic condition specific transforms 12A and 12B to generate groups of one or more words. Processor 18 may also execute the speech recognition algorithm using user and acoustic condition specific transform 14, even though transform 14 is specific to user device 4B, to convert the received speech data into a group of one or more words. In this example, processor 18 may estimate which one of transforms 12 or transform 14 resulted in more accurate speech recognition results, and may select the results for transmission based on the estimation.

In some instances, it may be beneficial for processor 18 to utilize different transforms and acoustic models, in addition to the user and acoustic condition specific transforms for the user device that transmitted the speech data. It may be possible that there is not sufficient previously collected speech data from a user device to accurately generate a plurality of user and acoustic condition specific transforms for that user device. In these examples, processor 18 may be able to select more accurate speech recognition results when processor 18 executes or utilizes multiple different transforms or models, e.g., acoustic model 22 and acoustic condition specific acoustic models 24.

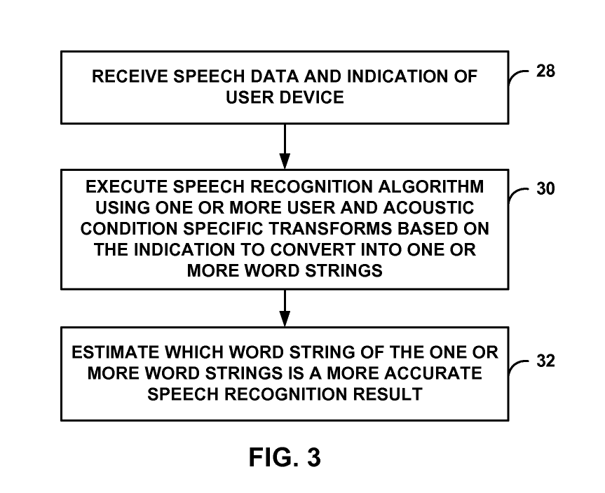

FIG. 3 is a flowchart illustrating an example operation of a speech recognition device. For example, the flowchart of FIG. 3 may illustrate an example operation of speech recognition devices 6A and 6B (FIGS. 2A and 2B). For purposes of illustration, reference is made to FIGS. 1, 2A, and 2B.

Speech data, from a user device, and an indication of the user device may be received (28). For example, a user of user device 4A may verbally provide speech to user device 4A. The verbally provided speech may be an example of speech data. In this example, speech recognition device 6A and/or 6B may receive the speech data from user device 4A. The speech data may include a particular acoustic condition.

In addition, in this example, speech recognition device 6A and/or 6B may also receive an indication of user device 4A. As one example, the indication of user device 4A may be the phone number of user device 4A. However, aspects of this disclosure are not so limited. The indication of the user device may be any identifier that uniquely identifies the user device.

A speech recognition algorithm that selectively uses one or more user and acoustic condition specific transforms may be executed based on the indication (30). In this manner, the speech data may be converted into one or more word strings, where each word string includes one or more words. For example, each user and acoustic condition specific transform may be associated with the indication of the user device. For instance, user and acoustic condition specific transforms 12A and 12B may be associated with the user device 4A and user and acoustic condition specific transform 14 may be associated with user device 4B. Processors 18 may determine whether the user and acoustic condition specific transforms are specific to the user device based on the indication of the user device.

Processor 18 may execute the speech recognition algorithm using user and acoustic condition specific transforms 12A, 12B, or 14 based on which one of user devices transmitted the speech data. For example, if user device 4B transmitted the speech data, as determined based on the transmitted indication, processor 18 may execute the speech recognition algorithm using user and acoustic condition specific transform 14. The execution of the speech recognition algorithm using user-specific acoustic models may cause processor 18 to convert the received speech data into one or more word strings, e.g., groups of one or more words, which represent the speech data.

An estimation of which word string of the one or more word strings more accurately represents the received speech data may be made to select an appropriate user and acoustic condition specific transform for conversion of the speech data into the word string estimated to more accurately represent the received speech data (32). The word strings may be considered as speech recognition results. In this example, an estimation of which speech recognition result more accurately represents the received speech data may be made. For example, if the speech data is from user device 4A, processor 18 may estimate which one of user and acoustic condition specific transforms 12A and 2B, when used by the speech recognition algorithm resulted in more accurate speech recognition results. In some examples, processor 18 may make the estimation based on confidence values that indicate the accuracy of the conversion of the speech data into one or more words.

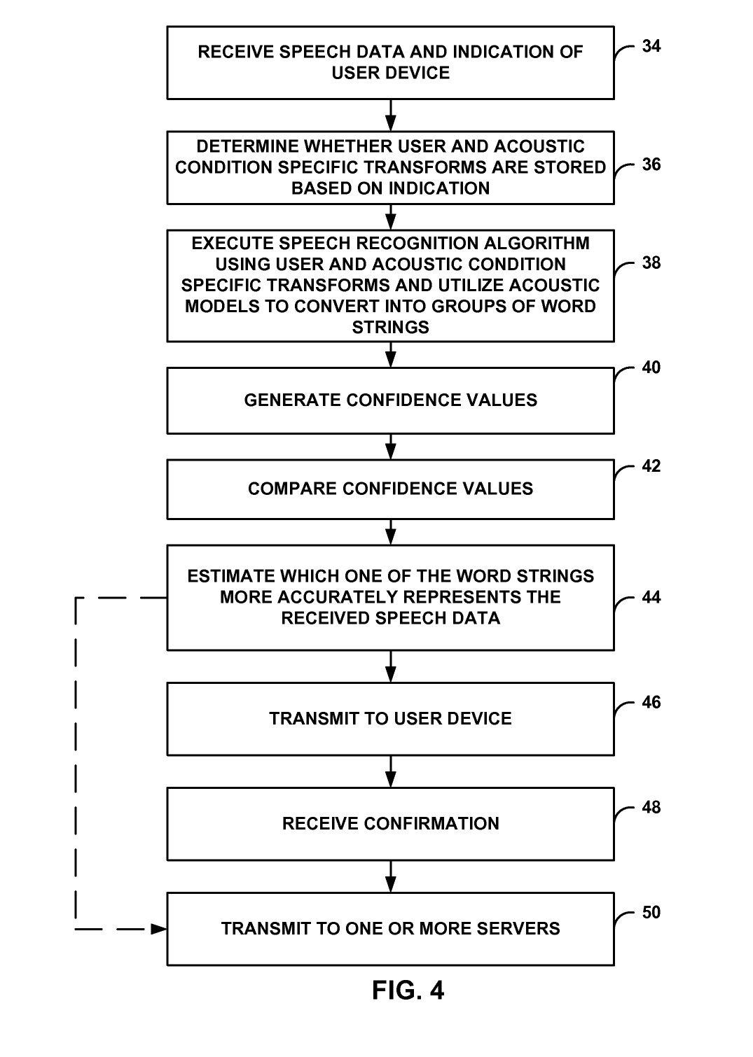

FIG. 4 is a flowchart illustrating another example operation of a speech recognition device. For example, the flowchart of FIG. 4 may illustrate another example operation of speech recognition device 6A or 6B (FIGS. 2A and 2B). For purposes of illustration, reference is made to FIGS. 1, 2A, and 2B.

Similar to the flowchart illustrated in FIG. 3, speech data, from a user device, and an indication of the user device may be received (34). The speech data may be speech by a user of one of user devices 4. The indication may be any identifier, e.g., phone number, that uniquely identifies the user device. The speech data may include a particular acoustic condition.

A determination of whether user and acoustic condition specific transforms are stored may be made based on the received indication (36). For example, processor 18 may determine whether one or more of speech recognition devices 4 store user and acoustic condition specific transforms for the user device that transmitted the speech data based on the indication for that user device. As one example, if user device 4A transmitted the speech data and the indication, processor 18 may determine that storage device 16A stores user and acoustic condition specific transforms 12A and 12B that are specific to user device 4A based on the indication. As described above, user and acoustic condition specific transforms 12A and 12B may be associated with the indication of user device 4A. As another example, if user device 4D transmitted the speech data and the indication, processor 18 may determine that none of the user and acoustic condition specific transforms, stored on storage device 16A, are associated with user device 4D. Processor 18A may make the determination based on the indication of user device 4D.

A speech recognition algorithm using user and acoustic condition specific transforms may be executed to convert the speech data into a group of word strings, e.g., one or more word strings (38). Also, in some examples, acoustic models, such as acoustic model 22 and/or acoustic condition specific acoustic models 24 may be utilized to convert the received speech data into word strings. Execution of the speech recognition algorithm using the user and acoustic condition specific transforms and utilization of the acoustic models may each transform the received speech data into a word string that represents the speech data. For example, processor 18 may execute the speech recognition algorithm using the user and acoustic condition specific transforms that are specific to the user device that transmitted the speech data and the indication. In some non-limiting example, processor 18 may also utilize the mathematical models of acoustic model 22 and/or acoustic condition specific acoustic models 24. However, aspects of this disclosure are not so limited. It may not be necessary to utilize the mathematical models of acoustic model 22 and/or acoustic condition specific acoustic models 24 in every examples of this disclosure.

In some examples, confidence values for each executed user and acoustic condition specific transforms and utilized mathematical models of acoustic model 22 and/or acoustic condition specific acoustic models 24 may be generated (40). However, the confidence values need not be generated in every example. The confidence value may estimate the accuracy of the conversion of the received speech data into a word string for a particular transform. For example, after processor 18 may execute the speech recognition algorithm using user and acoustic condition specific transform 12A, processor 18 may generate a first confidence value that estimates the accuracy of the conversion of the received speech data into a word string. After processor 18 executes the speech recognition algorithm using user and acoustic condition specific transform 12B, processor 18 may generate a second confidence value.

The confidence values may be compared (42). For instance, keeping with the previous example, processor 18 may compare the first confidence value with the second confidence value. Also, in some examples, processor 18 may compare the confidence values generated from user and acoustic condition specific transforms and the confidence values generated from the acoustic model and/or confidence values generated from the acoustic condition specific acoustic models.

An estimation of which one of the word strings more accurately represents the received speech data may be made (44). For example, an estimation of which user and acoustic condition specific transform more accurately converted the speech data into a word string may be made. For instance, keeping with the previous example, processor 18 may determine that the first confidence value is greater than the second confidence value. In this example, processor 18 may estimate that the word string generated by the execution of the algorithm of user and acoustic condition specific transform 12A more accurately represent the speech data as compared to the other word strings generated by the execution of the algorithm of user and acoustic condition specific transform 12B. Moreover, in some examples, processor 18 may also determine which word string, generated from user and acoustic condition specific transforms, from an acoustic model, e.g., acoustic model 22, and/or from one or more acoustic specific acoustic models, e.g., acoustic specific acoustic models 24, more accurately represents the received speech data.

In some examples, the word string that is estimated to be the most accurate representation of the speech data may be transmitted directly to one or more servers 8 (50). In some alternate examples, the word string that is estimated to be the most accurate representation of the speech data may be transmitted to the user device that transmitted the speech data (46). However, examples of this disclosure are not so limited. The transmission of the word string may not need to be transmitted to the user device that transmitted in speech data in all examples.

In examples where the word string that is estimated to more accurately represent the speech data is transmitted to the user device, confirmation may be received indicating whether the word string accurately represents the speech data (48). For example, the user device that transmitted the speech data may receive the word string. The user device may then display the word string to the user. The user may then confirm whether the displayed word string is equivalent to the speech data. If the displayed word string is equivalent to the speech data, the user may cause the user device to transmit a confirmation signal that confirms that the word string accurately represents the speech data. After confirmation, the word string may be transmitted to one or more servers 8 (50). If the displayed word string is not equivalent to the speech data, the user may provide the speech data again.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as RAM, ROM, NVRAM, EEPROM, FLASH memory, magnetic or optical data storage media, and the like. The code or instructions may be software and/or firmware executed by processing circuitry including one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

Various aspects have been described in this disclosure. These and other aspects are within the scope of the following claims.

1. A method comprising:
receiving speech data from a user device;
receiving an indication of the user device;
executing a speech recognition algorithm that selectively retrieves, from one or more storage devices, a plurality of pre-stored user and acoustic condition specific transforms based on the received indication of the user device, and that utilizes the received speech data as an input into pre-stored mathematical models of the retrieved plurality of pre-stored user and acoustic condition specific transforms to convert the received speech data into one or more word strings that each represent at least a portion of the received speech data, wherein each one of the plurality of pre-stored user and acoustic condition specific transforms is a transform that is both specific to the user device and specific to one acoustic condition from among a plurality of different acoustic conditions, wherein each of the different acoustic conditions comprises a context in which the speech data could have been provided, and wherein each of the plurality of pre-stored user and acoustic condition specific transforms and each of the pre-stored mathematical models that are utilized to convert the received speech data into the one or more word strings were generated and stored in the one or more storage devices prior to receipt of the speech data from the user device and prior to receipt of the indication of the user device;
estimating which word string of the one or more word strings more accurately represents the received speech data;
selecting, based on the estimation and from the plurality of user and acoustic condition specific transforms, an appropriate user and acoustic condition specific transform for conversion of the speech data into the word string estimated to more accurately represent the received speech data; and
transmitting the word string to at least one of the user device or one or more servers.

2-3. (canceled)

4. The method of claim 1, further comprising transmitting the word string estimated to more accurately represent the received speech data to the one or more servers.

5. The method of claim 1, wherein the plurality of pre-stored user and acoustic condition specific transforms are stored in a speech recognition device.

6. The method of claim 1, wherein the user device comprises a first user device, and wherein the plurality of pre-stored user and acoustic condition specific transforms comprise a first set of pre-stored user and acoustic condition specific transforms that are specific to the first user device, the method further comprising pre-storing a second set of one or more user and acoustic condition specific transforms that are specific to a second user device.

7. The method of claim 1, further comprising:
generating additional one or more word strings by utilizing an acoustic model that is not specific to the user device and not specific to an acoustic condition; and
estimating which word string of the one or more word strings and the additional one or more word strings more accurately represents the received speech data.

8. The method of claim 1, further comprising:
generating additional one or more word strings by utilizing one or more acoustic condition specific acoustic models that are not specific to the user device and are each specific to an acoustic condition; and
estimating which word string of the one or more word strings and the additional one or more word strings more accurately represents the received speech data.

9. The method of claim 1, further comprising:
generating confidence values for each of the plurality of pre-stored user and acoustic condition specific transforms used by the speech recognition algorithm, wherein the confidence values estimate an accuracy of conversion of the received speech data into the one or more word strings for each user and acoustic condition specific transform,
wherein estimating which word string of the one or more word strings more accurately represents the received speech data comprises estimating which word string of the one or more word strings more accurately represents the received speech data based on the confidence values.

10. The method of claim 1, wherein the one or more word strings each include one or more words that form the received speech data.

11. The method of claim 1, wherein receiving an indication of the user device comprises receiving a phone number of the user device.

12. The method of claim 1, wherein the one acoustic condition from among the plurality of different acoustic conditions of the speech data comprises one of speech data from a female in a quiet environment, speech data from a female in a noisy environment, speech data from a male in a quiet environment, speech data from a male in a noisy environment, speech data provided when the user device is proximate to a user, and speech data provided when the user device is further away from the user.

13. A computer-readable storage device comprising instructions that cause one or more processors to perform operations comprising:
receiving speech data from a user device;
receiving an indication of the user device;
executing a speech recognition algorithm that selectively retrieves, from one or more storage devices, a plurality of pre-stored user and acoustic condition specific transforms based on the received indication of the user device, and that utilizes the received speech data as an input into pre-stored mathematical models of the retrieved plurality of pre-stored user and acoustic condition specific transforms to convert the received speech data into one or more word strings that each represent at least a portion of the received speech data, wherein each one of the plurality of pre-stored user and acoustic condition specific transforms is a transform that is both specific to the user device and specific to one acoustic condition from among a plurality of different acoustic conditions, wherein each of the different acoustic conditions comprises a context in which the speech data could have been provided, and wherein each of the plurality of pre-stored user and acoustic condition specific transforms and each of the pre-stored mathematical models that are utilized to convert the received speech data into the one or more word strings were generated and stored in the one or more storage devices prior to receipt of the speech data from the user device and prior to receipt of the indication of the user device;
estimating which word string of the one or more word strings more accurately represents the received speech data;
selecting, based on the estimation and from the plurality of user and acoustic condition specific transforms, an appropriate user and acoustic condition specific transform for conversion of the speech data into the word string estimated to more accurately represent the received speech data; and
transmitting the word string to at least one of the user device or one or more servers.

14-15. (canceled)

16. The computer-readable storage device of claim 13, further comprising instructions for transmitting the word string estimated to more accurately represent the received speech data to the one or more servers.

17. The computer-readable storage device of claim 13, wherein the plurality of pre-stored user and acoustic condition specific transforms are stored in a speech recognition device.

18. The computer-readable storage device of claim 13, wherein the user device comprises a first user device, and wherein the plurality of pre-stored user and acoustic condition specific transforms comprise a first set of pre-stored user and acoustic condition specific transforms that are specific to the first user device, the method further comprising pre-storing a second set of one or more user and acoustic condition specific transforms that are specific to a second user device.

19. The computer-readable storage device of claim 13, wherein the one acoustic condition from among the plurality of different acoustic conditions of the speech data comprises one of speech data from a female in a quiet environment, speech data from a female in a noisy environment, speech data from a male in a quiet environment, speech data from a male in a noisy environment, speech data provided when the user device is proximate to a user, and speech data provided when the user device is further away from the user.

20. A speech recognition device comprising:
a transceiver that receives speech data from a user device and an indication of the user device;
one or more storage devices that pre-store a plurality of user and acoustic condition specific transforms prior to the receipt of the speech data, and mathematical models of the user and acoustic condition specific transforms prior to the receipt of the speech data, wherein each one of the plurality of pre-stored user and acoustic condition specific transforms is a transform that is both specific to the user device and specific to one acoustic condition from among a plurality of different acoustic conditions, and wherein each of the different conditions comprises a context in which the speech data could have been provided; and
one or more processors configured to:
execute a speech recognition algorithm that selectively retrieves the plurality of user and acoustic condition specific transforms based on the received indication of the user device, and that utilizes the received speech data as an input into the mathematical models of the retrieved plurality of pre-stored user and acoustic condition specific transforms to convert the received speech data into one or more word strings that each represent at least a portion of the received speech data, wherein each of the plurality of pre-stored user and acoustic condition specific transforms and each of the pre-stored mathematical models that are utilized to convert the received speech data into the one or more word strings were generated and stored in the one or more storage devices prior to receipt of the speech data from the user device and prior to receipt of the indication of the user device; and
estimate which word string of the one or more word strings more accurately represents the received speech data, and select, based on the estimation and from the plurality of user and acoustic condition specific transforms, an appropriate user and acoustic condition specific transform for conversion of the speech data into the word string estimated to more accurately represent the received speech data,
wherein the transceiver is configured to transmit the word string to at least one of the user device or one or more servers.
